(19) United States
(12) Patent Application Publication
(10) Pub. No.: US 2024/0174536 A1
(43) Pub. Date: May 30, 2024

(54) ENHANCED PLUME SPREADING

(71) Applicant: THE REGENTS OF THE UNIVERSITY OF COLORADO, A BODY CORPORATE, Denver, CO (US)

(72) Inventors: David C. MAYS, Denver, CO (US); Ryan G. TIGERA, Englewood, CO (US); Whitney BENSON, Austin, TX (US)

(21) Appl. No.: 18/520,924

(22) Filed: Nov. 28, 2023

Related U.S. Application Data
(60) Provisional application No. 63/385,101, filed on Nov. 28, 2022.

(51) Int. Cl. C02F 1/72; C02F 3/00; C02F 101/00; C02F 101/22; C02F 101/32; C02F 101/36; C02F 103/06

(52) U.S. Cl. CPC C02F 1/72; C02F 3/00; C02F 2101/006; C02F 2101/22; C02F 2101/322; C02F 2101/36; C02F 2103/06; C02F 2305/04

(57) ABSTRACT

A method of enhancing plume spreading, the method comprising: injecting a first fluid having a first viscosity into a second fluid having a second viscosity; wherein the first viscosity is lower than the second viscosity; and wherein an interface between the first fluid and the second fluid has a surface area that is greater than a reference surface area of an interface between two fluids having a same viscosity, thereby enhancing plume spreading of the first fluid into the second fluid.

### CROSS REFERENCE TO RELATED APPLICATIONS

This application claims the benefit of priority to U.S. Provisional Application No. 63/385,101, filed Nov. 28, 2022, which is incorporated by reference herein in its entirety.

### BACKGROUND

Reactive transport in porous media is important for a number of natural and engineered processes, including geochemical cycling, in situ mining, and groundwater remediation. In any of these applications, a plume of reactant is introduced—either naturally or deliberately—into the resident fluid in the porous media. The reaction depends on mixing the reactant with the resident fluid, which fundamentally depends on molecular diffusion, but practically depends on a process called plume spreading. Plume spreading transforms the reactant plume into a fractal-like network of lamella that are thin enough for molecular diffusion to bring reactants together. Because flows in porous media are typically laminar, which precludes the turbulence that provides mixing in other engineered reactors, reactions in porous media are transport limited. Accordingly, the transport of reactants in porous media is governed by the process of plume spreading.

Plume spreading can be classified as passive or active. Passive spreading results from the heterogeneity that is inherent in essentially any natural porous media. Finding the paths of least resistance, the fluid establishes channels of preferential flow, and the resulting velocity contrasts enhance plume spreading compared to a hypothetical baseline of homogeneous media. In this context, mass transport by transverse dispersion is known to be an important process. By contrast, active spreading results from the deliberate manipulation of the velocity field through an approach called engineered injection and extraction, for example, through vertically separated segments of the well screen, through a manifold of wells, or through a rotated dipole mixer. However, this deliberate manipulation is not always feasible because of the additional expense of drilling multiple wells, the additional expense of plumbing for injection and extraction, and in the case of groundwater remediation, the additional expense of gaining regulatory approval for re-injection of potentially contaminated waters.

As such, there is a need for improved plume spreading. This need and others are at least partially satisfied by the present disclosure.

### SUMMARY

Disclosed herein is plume spreading enhanced by decreasing the viscosity of the injected fluid (i.e., by changing its temperature or adding a viscosity reducing agent), which enhances viscous fingering. The injected water has a lower viscosity, which renders an increased mobility ratio and generates elongated plume perimeters for essentially consistent plume areas, which enhances miscible plume spreading in porous media. The methods disclosed herein can be used, for example, to improve mixing of a remediation amendment into a contaminated groundwater aquifer or increase the reach of a lixiviant used for in situ mining.

In an aspect, provided is a method of enhancing plume spreading, the method comprising: injecting a first fluid having a first viscosity into a second fluid having a second viscosity; wherein the first viscosity is lower than the second viscosity; and wherein an interface between the first fluid and the second fluid has a surface area that is greater than a reference surface area of an interface between two fluids having a same viscosity, thereby enhancing plume spreading of the first fluid into the second fluid.

In another aspect, provided is a method of groundwater remediation, the method comprising: injecting a fluid into a portion of groundwater; wherein the fluid has a first temperature and comprises a remediation amendment; wherein the groundwater has a second temperature and comprises at least one contaminant; wherein the first temperature is higher than the second temperature; wherein an interface between the groundwater and the injected fluid has a surface area that is greater than a reference surface area of an interface between groundwater and a reference injected fluid at the second temperature; and wherein the remediation amendment diffuses into the groundwater at the interface, thereby destroying, transforming, or immobilizing the at least one contaminant.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

FIG. 1 depicts a schematic of an experimental apparatus, where the cold defending fluid (i.e., the second fluid) is blue, the hot invading fluid (i.e., the first fluid) is yellow, and the mixed fluid is green. Red arrows are injections; blue arrows are extraction. Syringe pump 1 connects via a four-way valve to the reservoir of hot invading fluid, the center injection port, and the waste line; syringe pump 2 connects via a three-way valve to the reservoir of cold defending fluid and the right extraction port.

FIGS. 2A-2D depict thermally enhanced plumes after injection of 60 mL for Experiment 1 at Pe=320 (FIG. 2A), Experiment 2 at Pe=160 (FIG. 2B), Experiment 3 at Pe=80 (FIG. 2C), and Experiment 4 at Pe=40 (FIG. 2D).

FIG. 3 depicts results for experiment 1 with Pe=320 for cumulative injection volume 10 mL≤V≤60 mL. The isothermal control at left has mobility ratio R=0. The thermally enhanced test at right has mobility ratio R=1.2.

FIG. 4 depicts results for experiment 2 with Pe=160 for cumulative injection volume 10 mL≤V<60 mL. The isothermal control at left has mobility ratio R=0. The thermally enhanced test at right has mobility ratio R=1.2.

FIG. 5 depicts results for experiment 3 with Pe=80 for cumulative injection volume 10 mL≤V ≤60 mL. The isothermal control at left has mobility ratio R=0. The thermally enhanced test at right has mobility ratio R=1.2.

FIG. 6 depicts results for experiment 4 with Pe=40 for cumulative injection volume 10 mL≤V<60 mL. The isothermal control at left has mobility ratio R=0. The thermally enhanced test at right has mobility ratio R=1.2.

FIG. 7 depicts a binary image of the control plume (blue) superimposed on the thermally enhanced plume (white) for experiment 4 with Pe=40 after injection of 60 mL.

FIG. 8 depicts plume perimeter determined by binary image analysis versus injection volume for experiment 4 with Pe=40. The thermally enhanced test plume had a maximum perimeter of 5883 mm, which is 47% more than the corresponding control perimeter plume length of 4005 mm.

FIG. 9 depicts a morphological image of the control plume (blue) superimposed on the thermally enhanced plume (white) for experiment 4 with Pe=40 after injection of 60 mL.

FIG. 10 depicts plume perimeter determined by morphological image analysis versus injection volume for experiment 4 with Pe=40. The thermally enhanced test plume had a maximum perimeter of 649 mm, which is 56% more than the corresponding control perimeter plume length of 416 mm. For comparison, the dotted line is the perimeter of a theoretical circular cylinder that is 12 mm tall with a porosity of 0.36.

FIG. 11 depicts a view of the apparatus as seen from above.

FIG. 12 depicts a side profile of quasi-two-dimensional porous media apparatus of FIG. 11.

FIG. 13 depicts a diagram of the filling procedure.

### DETAILED DESCRIPTION

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Definitions

In this specification and in the claims that follow, reference will be made to a number of terms, which shall be defined to have the following meanings:

Throughout the description and claims of this specification, the word “comprise” and other forms of the word, such as “comprising” and “comprises, ” means including but not limited to, and are not intended to exclude, for example, other additives, segments, integers, or steps. Furthermore, it is to be understood that the terms comprise, comprising, and comprises as they relate to various aspects, elements, and features of the disclosed invention also include the more limited aspects of “consisting essentially of” and “consisting of.”

As used herein, the singular forms “a, ” “an, ” and “the” include plural referents unless the context clearly dictates otherwise. Thus, for example, reference to a “detergent” includes aspects having two or more such detergents unless the context clearly indicates otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about, ” it will be understood that the particular value forms another aspect. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

For the terms “for example” and “such as, ” and grammatical equivalences thereof, the phrase “and without limitation” is understood to follow unless explicitly stated otherwise.

### Methods

Disclosed herein are methods of enhancing plume spreading, particularly enhancing mixing via plume spreading. Plume spreading is typically observed in the injection of one fluid into another in the context of a porous media (e.g., soil). Plume spreading is commonly utilized in groundwater-based applications, for example, groundwater remediation or in situ mining. In such uses, a reactant (e.g., remediation amendment, lixiviant, etc.) is introduced into the groundwater via the injected plume. Many such reactants are characterized by conservative transport (i.e., the reactant moves at the same speed and direction as the injected fluid), and the plume itself is typically limited to laminar flow due to the narrow passageways of porous media. As such, the reactant can diffuse into the groundwater only by molecular diffusion across the plume interface, which limits the speed and reach of the mixing.

The disclosed methods advantageously enhance the mixing of the injected plume by modifying the viscosity of the injected fluid (by changing temperature, adding a viscosity reducing agent, or a combination thereof), thereby resulting in viscous fingering. These fingers protrude from the plume, thereby increasing the perimeter (when conceptualized in two dimensions) or surface area (when conceptualized in three dimensions) of the interface between the injected fluid and the groundwater. This increased surface area increases the rate of molecular diffusion of the reactant from the injected plume into the groundwater. These methods can further be applied to other systems of fluids where stirring, agitation, or other conventional means of mixing are infeasible or otherwise detrimental to the process.

In an aspect, provided is a method of enhancing plume spreading, the method comprising: injecting a first fluid having a first viscosity into a second fluid having a second viscosity; wherein the first viscosity is lower than the second viscosity; and wherein an interface between the first fluid and the second fluid has a surface area that is greater than a reference surface area of an interface between two fluids having a same viscosity, thereby enhancing plume spreading of the first fluid into the second fluid.

In some aspects, the first fluid and the second fluid are both liquids. In some aspects, the first fluid and the second fluid are both gases. In some aspects, the first fluid is miscible in the second fluid.

In some aspects, the first fluid has a first temperature and the second fluid has a second temperature, and the first temperature is higher than the second temperature. In some aspects, the first temperature is higher than the second temperature by from about 10° C. to about 100° C., or from about 20° C. to about 80° C., or from about 30° C. to about 70° C., or from about 40° C. to about 60° C., or from about 10° C. to about 50° C., or from about 20° C. to about 40° C., or from about 50° C. to about 100° C., or from about 60° C. to about 90° C., or from about 70° C. to about 80° C.

In some aspects, the first fluid further comprises a viscosity reducing agent. In some aspects, the viscosity reducing agent comprises a detergent, surfactant, excipient, or any combination thereof.

In some aspects, a mobility ratio (i.e., log viscosity ratio) between the first fluid and the second fluid is from about 1 to about 2, or from about 1.1 to about 1.9, or from about 1.2 to about 1.8, or from about 1.3 to about 1.7, or from about 1.4 to about 1.6, or from about 1 to about 1.5, or from about 1.1 to about 1.4, or form about 1.2 to about 1.3, or from about 1.5 to about 2, or from about 1.6 to about 1.9, or from about 1.7 to about 1.8.

In some aspects, the first fluid is water and comprises a soluble reactant. In some aspects, the soluble reactant comprises a remediation amendment, a lixiviant, or a combination thereof. In some aspects, the remediation amendment comprises a reactant for chemical oxidation (e.g., potassium permanganate), a reactant for bioremediation (e.g., molasses), or a combination thereof. In some aspects, the lixiviant comprises a carbonate solution (e.g., sodium bicarbonate) or an acid solution (i.e., sulfuric acid). In some aspects, the second fluid is groundwater.

In some aspects, the interface comprises viscous fingering. In some aspects, the surface area of the interface is greater than the reference surface area by from about 20% to about 140%, or from about 40% to about 120%, or from about 60% to about 100%, or from about 20% to about 80%, or from about 30% to about 70%, or from about 40% to about 60%, or from about 80% to about 140%, or from about 90% to about 130%, or from about 100% to about 120%.

In another aspect, provided is a method of groundwater remediation, the method comprising: injecting a fluid into a portion of groundwater; wherein the fluid has a first temperature and comprises a remediation amendment; wherein the groundwater has a second temperature and comprises at least one contaminant; wherein the first temperature is higher than the second temperature; wherein an interface between the groundwater and the injected fluid has a surface area that is greater than a reference surface area of an interface between groundwater and a reference injected fluid at the second temperature; and wherein the remediation amendment diffuses into the groundwater at the interface, thereby destroying, transforming, or immobilizing the at least one contaminant.

In some aspects, the at least one contaminant comprises hydrocarbons such as benzene, organic solvents such as trichloroethylene, heavy metals such as chromium, radionuclides such as uranium, or other contaminants dissolved in water.

In some aspects, the fluid is an aqueous solution. In some aspects, the remediation amendment comprises a reactant for chemical oxidation (e.g., potassium permanganate), a reactant for bioremediation (e.g., molasses), or a combination thereof.

In some aspects, the first temperature is higher than the second temperature by from about 10° C. to about 100° C., or from about 20° C. to about 80° C., or from about 30° C. to about 70° C., or from about 40° C. to about 60° C., or from about 10° C. to about 50° C., or from about 20° C. to about 40° C., or from about 50° C. to about 100° C., or from about 60° C. to about 90° C., or from about 70° C. to about 80° C.

In some aspects, the fluid further comprises a viscosity reducing agent. In some aspects, the viscosity reducing agent comprises a detergent, surfactant, excipient, or any combination thereof.

In some aspects, the surface area of the interface is greater than the reference surface area by from about 20% to about 140%, or from about 40% to about 120%, or from about 60% to about 100%, or from about 20% to about 80%, or from about 30% to about 70%, or from about 40% to about 60%, or from about 80% to about 140%, or from about 90% to about 130%, or from about 100% to about 120%.

### EXAMPLES

### Example 1: Thermally Enhanced Spreading of Miscible Plumes in Porous Media

Introduction: A study was conducted which proposed a new approach to active plume spreading by heating the injected water. Rather than imposing an engineered velocity field, this approach sought to enhance plume spreading through the fundamental physics of fluid displacement. Fluid displacement is the process by which a certain fluid, called the defending fluid (i.e., the second fluid), is replaced by a different fluid, called the invading fluid (i.e., the first fluid). This process can be classified as stable or unstable. Stable displacement causes the complete replacement of the defending fluid by the invading fluid, for example, when a more viscous fluid displaces a less viscous fluid of equal density or when a dense fluid displaces a light fluid from below. Neglecting hydrodynamic dispersion, stable displacement manifests itself as the plug flow, which is the default conceptual model for many environmental treatment unit operations and for groundwater remediation hydraulics, including pump-and-treat and engineered injection and extraction. By contrast, unstable displacement causes an unstable interface between the defending and invading fluids, causing incomplete replacement. In the context of engineered reactive transport, this unstable interface generates the additional plume spreading of the invading fluid into the defending fluid, called fingering, which provides an opportunity for enhanced mixing by molecular diffusion, and, consequently, a more complete reaction.

Unstable displacement results from various combinations of interfacial tension, density difference, or viscosity difference. When the interfacial tension is nonzero, the displacement is called immiscible, examples of which include enhanced oil recovery and the removal of non-aqueous phase liquids (NAPLs). When the interfacial tension is zero, the displacement is called miscible, for example, when an aqueous chemical or biological amendment is injected into a contaminated groundwater aquifer, which is the focus of the present study. When miscible fluids have an unequal density, a lighter invading fluid fingers into a denser defending fluid during the upward flow, and a denser invading fluid fingers into a lighter defending fluid during the downward flow through a process called gravity fingering [10]. In contrast, for constant-density fluids, gravity fingering is prevented. While it is certainly possible to imagine a groundwater remediation application where the injected aqueous amendment has a significant density difference from the defending groundwater, the focus of the present study is on the viscous fingering of miscible fluids with a constant density.

Viscous fingering results when a less viscous fluid breaks through the miscible interface and creates a new pathway into the more viscous fluid [11-12]; viscous fingering always occurs when a less viscous fluid displaces a more viscous one, regardless of miscibility [13]. Viscous fingering can result from the native viscosity difference of the fluids [14-15] or from varying the injection rate over several orders of magnitude to create new flow regimes [16]. Here, we considered the viscous fingering caused by an imposed temperature that renders a viscosity difference between otherwise identical defending and invading fluids.

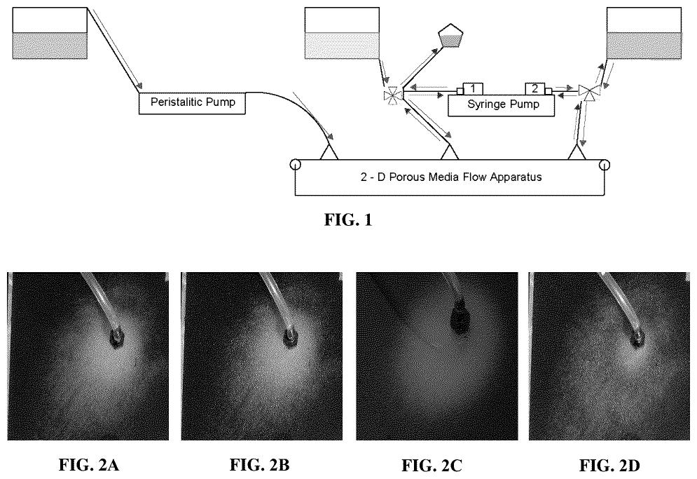

Viscous fingering between miscible fluids (FIG. 1) depends on two dimensionless numbers: the mobility ratio R, and the Péclet number, Pe [15, 17]. The mobility ratio, also called the log-viscosity ratio [e.g., 17], quantified the viscosity difference between two miscible fluids, where R>0 was required for viscous fingering, and larger values of R indicated that viscous fingering was more likely. The mobility ratio can be defined as:

$$R = ln ( \frac{{μ}_{1}}{{μ}_{2}} )$$

where μ₁ is the dynamic viscosity of the defending fluid and μ₂ is the dynamic viscosity of the invading fluid. The Péclet number is a dimensionless ratio of advection to diffusion, which quantifies the general pattern of advection, imposing fine structure on plumes, while diffusion smooths out fine structure. The Péclet number is defined as:

$$Pe = \frac{v L}{D}$$

where v is the fluid velocity, L is a characteristic length, and D is the fluid's self-diffusion constant.

There have been several studies involving temperature as a factor in groundwater remediation. Kaslusky and Udell [18] injected steam to enhance the removal of volatile organic compounds (VOCs), especially dense non-aqueous phase liquids (DNAPLs), from groundwater but did not specifically address mixing, spreading, or fingering. Kosegi et al. [19] found that increasing the temperature across the entire system in an aquifer remediation simulation resulted in faster cleanup times, but their study only noted changes in viscosity without considering changes in plume morphology. Similarly, Payne et al. [20] identified thermal effects in groundwater remediation hydraulics but did not consider plume morphology. Jackson et al. [21] modeled temperature difference between two immiscible fluids that already had a difference in viscosity, and they found that increasing the temperature difference increased the interfacial area, echoing similar results achieved by a model by Islam and Azaiez [22] that assumed the fluids were miscible. Both of these studies graphically analyzed the interfacial length between the invading plume and the defending fluid. However, a review of the literature has yet to identify research in terms of which enhanced plume spreading can be achieved by heating the invading fluid, thus lowering its viscosity. Accordingly, this study explored plume spreading by injecting a hot invading fluid into a cold defending fluid.

Materials and Methods: Thermally enhanced plume spreading was investigated by injecting a yellow-dyed hot invading fluid over a range of injection rates and into a quasi-2D apparatus packed with porous media and saturated with a blue-dyed cold-defending fluid. Photographs were recorded after each 10 mL of injection, and images were analyzed using k-means clustering with both binary and morphological analysis. The results were reported as an increased plume perimeter compared to an isothermal control. Details on each of these points are presented below, and additional information is provided elsewhere [23].

Apparatus: A quasi-2D porous media apparatus was constructed by etching a 305 mm×305 mm square into a clear acrylic sheet to a depth of 12 mm. The resulting chamber was filled with glass beads of a diameter of 1 mm, rendering a porosity of n=0.36 and assuming close random packing [24]. To provide a watertight seal for the acrylic lid, two parallel channels were carved outside the perimeter of the etched square for inner and outer rubber gaskets with circular cross-sections. The lid was secured by 24 round washer head screws (six on each side). Three ports were drilled along a diagonal between opposite corners of the square chamber (one in each corner and one in the center) and were tapped with threads to accommodate them, nominally as a ¼, in PVC plastic barbs.

The chamber was filled with saturated media by temporarily mounting the apparatus on a vertical jig, sealing the lower barb with Parafilm, removing the middle and upper barbs, and adding a slurry of beads and blue-dyed water through a tube inserted first into the middle port, and then into the upper port. A piece of stainless-steel mesh was added to each port before reinstalling the middle and top barbs to prevent the beads from being extracted during experiments. Once the barbed tube connection was tight, the cell was slowly lowered to a horizontal position for testing.

Once the cell was placed horizontally, a tripod was used to mount a 20.4-megapixel camera (Sony DSC-HX300, Tokyo, Japan) set to a high-resolution automatic portrait mode, with pictures were taken using a remote shutter to avoid movement. A consistent photograph orientation was provided by the middle barb and a mark placed on the apparatus lid that appeared in the upper-right of each image.

Experiments: Four experiments were performed over a range of decreasing injection rates (TABLE 1). In each experiment, the defending fluid was tap water dyed with 10 drops of blue dye (Standard Blue 106002, Kingscote Chemicals, Miamisburg, OH, USA) per 100 mL, and the invading fluid was tap water dyed with 10 drops of yellow dye (Yellow Color 53-140,Honeyville Grain. Ogden. UT. USA) per 100 mL. Identical dye concentrations were chosen to avoid density-driven flows.

TABLE 1
Overview of plume spreading experiments.

| Experiment | Discharge [mL/min] | Péclet Number | FIG. |
|---|---|---|---|
| 1 | 60 | 320 | 3 |
| 2 | 30 | 160 | 4 |
| 3 | 15 | 80 | 5 |
| 4 | 7.5 | 40 | 6 |

In the control experiments, both fluids were maintained at room temperature at approximately 22° C. The invading fluid was injected through the center port (FIG. 1), while the defending fluid was simultaneously removed from the right port, as required by continuity, to prevent over-pressurizing the apparatus. Close to the center port, the flow was approximately radial; farther from the center port, the flow approximated a dipole (disturbed by the boundary of the square chamber). In each experiment, a 60 mL syringe was filled with invading fluid and placed in the syringe pump, while an empty syringe was placed at the other side of the syringe pump to receive the defending fluid. Injection rates (TABLE 1) corresponded to 60 mL injected over 1, 2, 4, and 8 mins. Photographs were recorded after each 10 mL of injection up to 60 mL. Once the invading fluid was injected and the defending fluid was extracted, to prepare for the next experiment, the pump was reversed to re-inject the blue defending fluid and extract the yellow invading fluid (some of which will have mixed to green) to waste. The receiving vessel was elevated to maintain a positive gauge pressure in the apparatus in order to avoid introducing air bubbles.

In thermally enhanced experiments, the steps above were followed with several modifications. The defending fluid was cooled to a temperature of 11° C., somewhat below the average groundwater temperature of approximately 15° C. in Colorado, USA [25]. A total of 60 mL of cold blue fluid from this chilled reservoir was then injected by the syringe pump through the left port, while room-temperature blue fluid was extracted through the right port into a vessel placed above the flow chamber. This process of injecting 60 mL batches of cold blue fluid was repeated six times to ensure the entire cell was isothermal. Meanwhile, the invading fluid was boiled on a hot plate and then, after the fluid handling described below, was injected at 73° C. The injection fluid was assumed to have the same density as the defending fluid because the slight density decrease (2.4% from 11° C. to 72° C.) from heating was assumed to compensate for the slight density increase from the evaporative concentration of the yellow dye. The syringe was filled with hot water first, then the tube from the syringe to the four-way valve (FIG. 1), and then the tube from the four-way valve to the flow chamber. The tube from the syringe to the four-way valve was fitted with insulation, but the tube from the four-way valve to the chamber was not insulated to minimize blocking the plume from the camera.

Analysis: The viscosity of water as a function of temperature was estimated using the correlation of Sharqawy et al. [26]:

$$μ = 4.2844 \times 1 {0}^{- 5} + \frac{1}{0.157 {( T + 64.993 )}^{2} - 91.296}$$

where u is the dynamic viscosity of water [kg m⁻¹s⁻¹], and T is the temperature [° C.] in the range of 0≤T≤100° C. at sea level with an atmospheric pressure of 0.1 MPa. This equation is assumed to be valid at Denver's atmospheric pressure of approximately 84 kPa. For the defending fluid at 11° C. and the invading fluid at 73° C, this equation gives μ₁=1.3×10⁻³ kg m⁻¹s⁻¹ and μ₂=3.9×10⁻⁴ kg m⁻¹s⁻¹, respectively, rendering the mobility ratio R=1.2.

Because the injection flow is approximately radial, velocity declines with the distance from the center port, so it is necessary to define a characteristic radius at which to evaluate the velocity. This characteristic radius was chosen to be 54 mm, corresponding to the radius of a theoretical circular cylinder 12 mm tall with a porosity of 0.36 after an injection volume of 40 mL, after which thermally enhanced plume spreading was observed, as presented below. The characteristic length L=0.1 cm was taken as the diameter of the glass beads, and the self-diffusion coefficient D=2.14×10⁻⁵ cm²/sec was taken for the water at 22° C. [27]. These assumptions define a characteristic Péclet number for each of the experiments (TABLE 1).

Photographs were analyzed to quantify the plume geometry as the area and perimeter of the invading plume, where thermally enhanced experiments were compared to isothermal controls. These geometric results were determined using the Image Region Analyzer in MATLAB R2019b [28] for images generated by each of the two methods. Both methods began with color segmentation using k-means clustering and were implemented with the L*a*b* color space and cluster command in MATLAB R2019b. This command separated the k=3 colors of blue (defending), yellow (invading), and green (mixed) in the raw photograph into clusters. In the first image analysis method, the cluster representing the yellow invading plume was converted to a binary image and used to quantify plume geometry. The second image analysis method was morphological structuring, which was implemented with the command strel in MATLAB R2019b. This command is specific to shapes and assigns a value to each pixel in relation to the other pixels in its vicinity. Once the image was flattened with the strel command, the imfill command was used to fill the holes within the image to create a continuous shape, accounting for the space occupied by the invading fluid supply tube and the barb fitting.

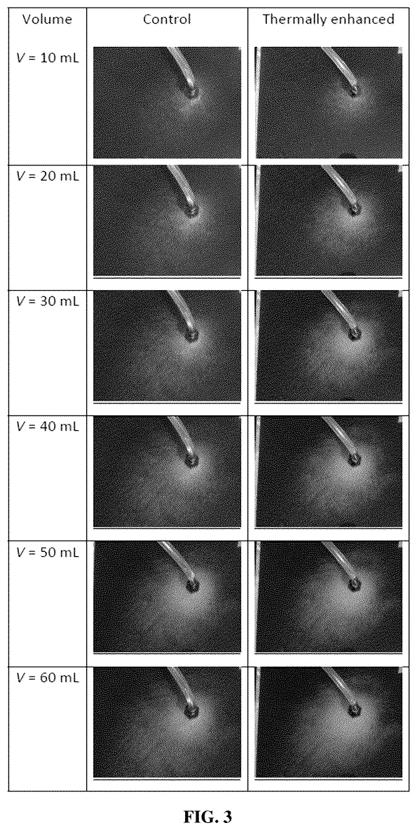

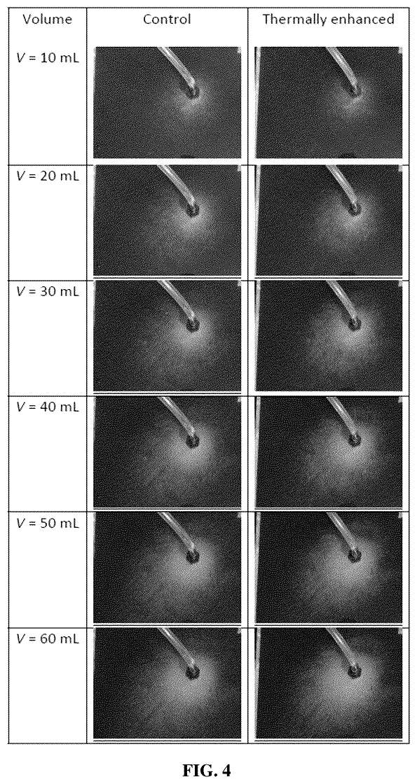

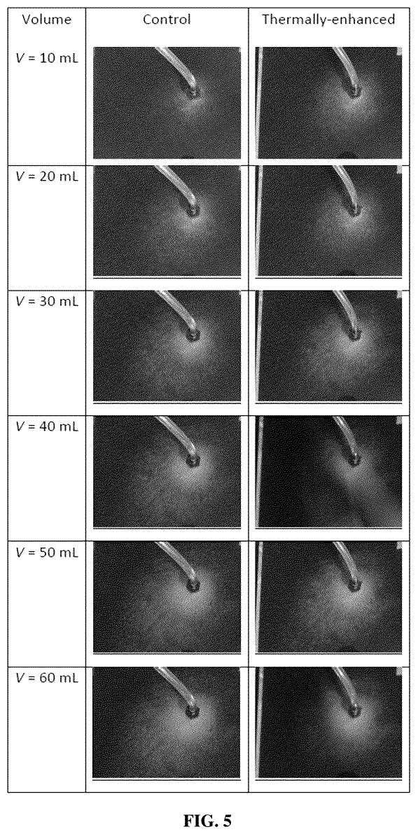

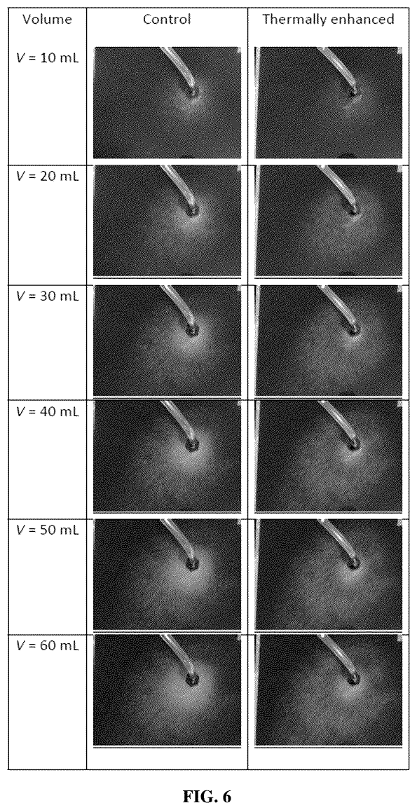

Results: The invading plume after the final injection volume of 60 mL is shown for each experiment 1-4 in FIGS. 2A-2D, and complete results are provided in the Supplementary Information (FIG. 3, FIG. 4, FIG. 5, FIG. 6). By construction, the volume of the invading fluid was constant across experiments; the quasi-2D nature of the flow was confirmed by noting that areas, determined by both the image analysis methods, are consistent at approximately 6300±200 mm² (plus or minus one standard error) for all thermally enhanced experiments and isothermal controls (TABLE 2). No significant differences were observed in the plume areas between the image analysis methods or between the tests and controls (p<0.05). The consistently measured plume area was approximately half that of a theoretical circular cylinder 12 mm tall with a porosity of 0.36 after an injection volume of 60 mL, reflecting certain imperfections that render the flow quasi-2D rather than strictly 2D. In contrast, the differences in the invading plume perimeter reflect increases with the decreasing Péclet number. Relative to the control, the plume perimeters were lower, comparable, and lower for Runs 1, 2, and 3, respectively, which could be attributed to experimental variation. For Run 4, at the lowest Péclet number, the plume perimeter increased up to 47% for the binary image analysis and up to 56% for the morphological image analysis.

TABLE 2
Mean areas of invading plumes [mm²] after 60 mL of injection.

Image Analysis Method (Results shown
plus or minus one standard error)

| | Binary | Morphological |
|---|---|---|
| control | 6610 ± 150 | 6540 ± 202 |
| test | 6108 ± 654 | 6025 ± 728 |

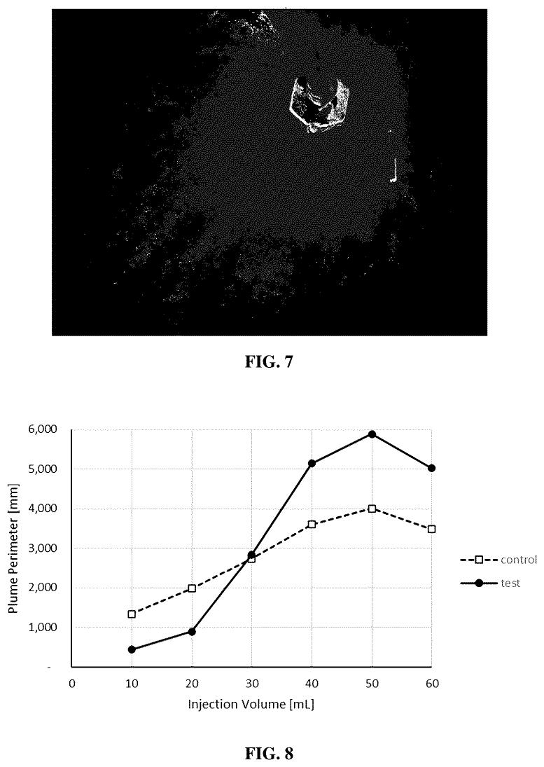

Binary Image Analysis: To illustrate the first image analysis method, FIG. 7 shows the binary image of plumes for experiment 4 after the injection of 60 mL with the isothermal control plume (in blue) superimposed on the thermally enhanced plume (in white). The elongation of the plume toward the lower-left corner of the image reflects the approximate dipole flow to the extraction port, which is not shown in order to discern more detail in the vicinity of the injection port. FIG. 8 shows how the perimeter of the invading plume in the thermally enhanced experiment evolved with time in comparison to the isothermal control. The slight reduction in perimeter between 50 and 60 mL of the injection may result from the dispersive blurring of the interface with time. The perimeter measured by binary image analysis was approximately ten times that measured by the morphological image analysis, as discussed below. This difference reflects the pixel-by-pixel nature of binary image analysis, which renders a much rougher perimeter. Nevertheless, in experiment 4, the perimeters were similar for injection volumes up to 30 mL, after which the thermally enhanced perimeter was up to 47% greater than the isothermal control.

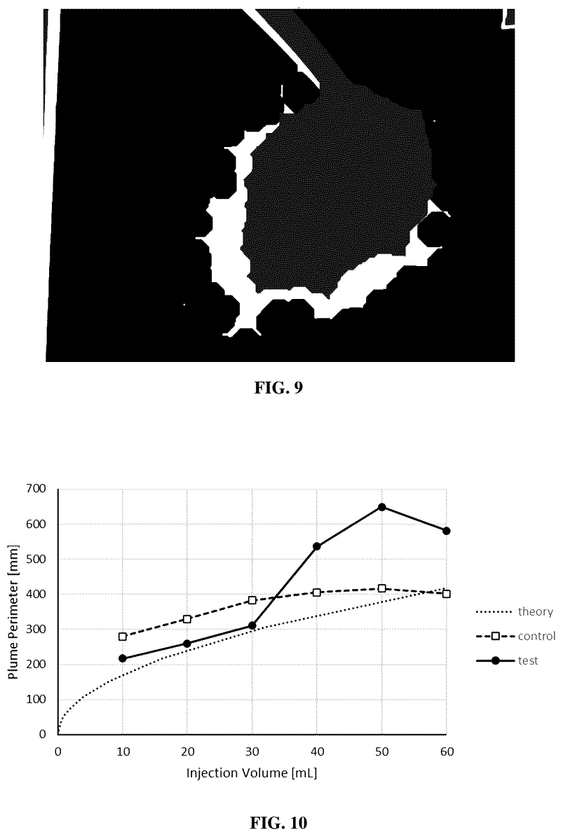

Morphological Image Analysis: To illustrate the second image analysis method, FIG. 9 shows the isothermal control plume (in blue) superimposed on the thermally enhanced plume (in white), and FIG. 10 shows how the perimeter of the invading plume in the thermally enhanced experiment evolved with time in comparison to the isothermal control. Again, it is speculated that the slight reduction in perimeter between 50 and 60 mL of the injection resulted from dispersive blurring. The perimeter of the isothermal control was slightly larger than that of a theoretical circular cylinder, appearing 12 mm tall with a porosity of 0.36, which is consistent with the flow approximating a dipole, which has a larger perimeter per area than a circular cylinder. The much smaller perimeter compared to binary image analysis reflects the feature of morphological image analysis that seeks to create contiguous regions, for example, by filling holes. However, the qualitative results matched the binary image analysis, with similar perimeters for injection volumes up to 30 mL, after which the thermally enhanced perimeter was up to 56% greater than the isothermal control.

Discussion: The proof-of-principle experiments presented here show the potential for the thermally enhanced spreading of injected plumes of miscible fluids in porous media. Elon-gated plume perimeters occur with a mobility ratio of R=1.2 and a Péclet number (as defined in TABLE 1) of Pe=40, and this observation is independent of the image analysis method chosen, since both binary and morphological analysis result in similar results. The binary image analysis (FIG. 7, FIG. 8) renders a fractal-like plume geometry with increases in perimeter compared to the isothermal control. The complementary morphological image analysis (FIG. 9, FIG. 10) renders a solid-like plume geometry also with increases in the perimeter. The combination of these methods provides a more in-depth understanding of the thermally enhanced plume spreading of miscible plumes in porous media.

It is notable that elongated plume perimeters can be generated even within the limited temperature range of liquid water that constrains the maximum possible mobility ratio. The maximum temperature range of 0° C. to 100° C. corresponds to a maximum viscosity range of μ₁=1.8×10⁻³ kg m⁻¹s⁻¹ to μ₂=2.8×10⁻⁴ kg m⁻¹s⁻¹, which corresponds to a maximum theoretical mobility ratio of R=1.9. Practically, the lower temperature is more or less fixed, perhaps reflecting some seasonal variation, but seldom comes close to freezing. The temperature T₁=11° C used here is probably a reasonable figure for temperate climates. Similarly, although the injection fluid can be heated to boiling, its temperature upon injection is limited by heat loss during fluid handling. If the tubes used in a field application are larger than the 6.4 mm (¼ in) diameter tubes used here, the smaller area-to-volume ratio limits heat loss; if the delivery time t=V/Q in a field application is smaller, this could also limit heat loss. Practically, the higher temperature may be higher than the T₂=73° C used here but seldom comes close to boiling. This limitation contrasts the present study with prior work by others, where higher temperatures generated steam and, consequently, introduced the immiscible displacement of water by steam. Such higher temperatures have been used in the remediation of NAPLs [18]. In contrast, the present study demonstrates the ability to clongate plume interfaces within a temperature range that one might expect in real aquifers and allows strictly miscible displacement.

The experiments reported here show more plume spreading with a decreasing Péclet number opposite the expectation for miscible plume spreading by viscous fingering [e.g., 29-30], but is at least qualitatively consistent with the results of Videbæk and Nagel [9], where the left panels show the suppression of 3D fingers and the right panels show the development of 2D fingers with a decreasing Péclet number. The present study differs from these three in at least two respects. First, the present study measures plume spreading in porous media rather than Hele-Shaw cells. Second, the present study generated plume spreading thermally, so the viscosity difference, and therefore, mobility ratio, depends on both fluid mixing and thermodynamics. That is, given enough time, the two fluids would reach thermal equilibrium with an equal viscosity and mobility ratio R=0. Accordingly, the results presented here may be somewhat counterintuitive because lower Péclet numbers imply lower velocities and correspondingly more time for the two fluids to reach thermal equilibrium, which drives the mobility ratio back toward zero. The observation of increased plume perimeter suggests that the time scale for elongating plume interfaces is shorter than the time scale for the thermal equilibrium, at least in the experiments reported here.

Another manifestation of the Péclet number effects could be observed in both the bi-nary image analysis (FIG. 8) and the morphological image analysis (FIG. 10). In both figures, the perimeter of the thermally enhanced invading plume began to exceed that of the isothermal control after 40 mL of the cumulative injection volume. This transition was observed only in experiment 4 with the smallest Pélet number Pe=40; it was not observed in other experiments with larger Péclet numbers (TABLE 1). This observation suggests that there is a critical Péclet number above which little thermally enhanced plume spreading occurs. In experiment 4, when the cumulative injection volume was 30 mL or less, the Péclet number was too high; when the cumulative injection volume was 40 mL or more, the Pélet number was low enough. In experiment 3, when the cumulative injection volume was 60 mL or less, the Péclet number was too high, which was similar to experiments 2 and 1, which had even higher injection rates. Accordingly, experiment 4 suggests a critical Péclet number in the range of 40-46, while experiment 3 suggests that the critical Péclet number is less than 65. Taken together, these results suggest that thermally enhanced plume spreading might have been expected in experiment 3 at a cumulative injection volume of 160 mL (although this larger volume would correspond to a longer injection time which could allow thermodynamics to eliminate the mobility ratio as discussed above).

Further experiments are required to address the limitations of this proof-of-principle study. First, the assumption of the equal density of invading and defending fluids should be tested. Second, a modified apparatus could prevent the inlet fitting and supply tubing from appearing in the plume images and using a deeper chamber could determine whether a fully 3D apparatus might reveal experimental artifacts in the quasi-2D apparatus. Third, additional experiments are required to further constrain the critical Péclet number and to determine whether enhanced plume spreading at lower injection rates (i.e., lower Péclet number) could be suppressed by the thermal equilibrium resulting from the additional injection time. Fourth, additional experiments are required to extend these results to 3D flows and reactive transport. For example, delivering hot amendments could accelerate reactions not only by improving plume spreading but also by hastening reaction kinetics. On the other hand, boiling (or nearly boiling) the injection fluid could preclude injecting amendments that are volatile, thermally unstable, or biologically active. Having stated these limitations, the observation of elongated plume interfaces in this experiment suggests that heating the injection fluid may increase the size and extent of the reactive inter-face between the injected plume and the native groundwater, which, in turn, may result in a larger volume of remediated groundwater. The results of the present study are the first steps toward quantifying the effectiveness of thermally enhanced plume spreading as a tool for in situ groundwater remediation.

### Example 2: Temperature Dependent Viscosity Driven Mixing in a Quasi 2D Porous Media Apparatus

Groundwater is an important resource for both domestic and agricultural uses. As civilization has advanced over the course of time, the technology to extract this resource has become more mechanical in nature. This increase in exploitation started in the 1950s as many industrialized nations turned these technologies toward groundwater exploitation (Foster & Chilton, 2003). Seen as a reliable, relatively clean source of water, groundwater wells provide a steady source of drinking water for residences. Furthermore, irrigation use has expanded due to its local availability and the evolution of pumping. Studies have shown the high crop yield and value of irrigation via a groundwater source (Llamas & Custodio, 2002).

The increased popularity of groundwater for consumptive use, whether it be domestic or irrigation, results in a greater awareness of the characteristics of the resource. Aquifer degradation is one of the major concerns regarding groundwater exploitation as it is a resource that is slow to recharge. The environmental aspects of this overuse are being explored and entities are starting to regulate the amount and the type of use. For example, the City of Aurora, CO requires all residents to connect to the City water supply when it is available at their property (City of Aurora, 1996). The groundwater rights are forfeited to the City, which saves this water as an emergency source to become a more resilient community. Besides overuse of the resource, regulations have become stricter on dumping and discharging of waste to avoid contamination of groundwater aquifers.

Contamination of the groundwater is difficult to clean due to its nature of being located underground, away from any opportunity to visually confirm the remediation. Typical methods of remediation require removing the groundwater from the aquifer, treating it in an external site and then injecting it back into the soil, a process called pump-and-treat. This can be an effective method of cleaning however it is expensive, time consuming and difficult to quantify the scenario in which the water is injected back into the aquifer. Contaminated soil can re-pollute the groundwater and reverse the attempts at a pump and treat remediation technique. Treating the water underground, in situ remediation, has been explored to treat the groundwater in a less expensive and hopefully more effective matter (Jones, 2014).

A study was conducted which explored in situ groundwater remediation by increasing the temperature of the injected fluid prior to insertion into the aquifer. This temperature difference created a viscosity difference that encouraged mixing and spreading of the neutralizing agent throughout the aquifer.

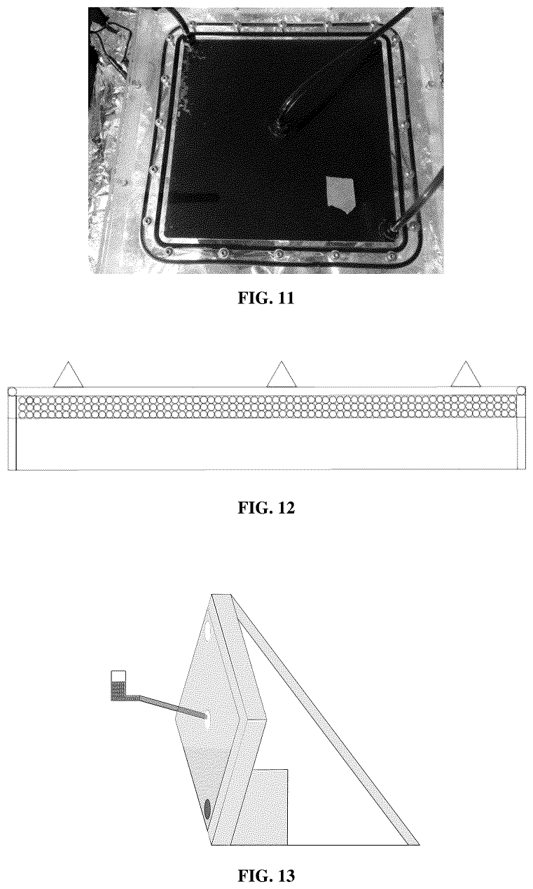

Methods: Apparatus: A quasi 2D porous media apparatus was constructed to model the formation of temperature driven viscous fingering as shown in FIG. 11. An acrylic box was inverted, and a 305 mm×305 mm (12×12-inch) square was etched in the center to a depth of 12 mm. The depth of the etching square had a volume of 1,100 cm³ which was filled with approximately 530,000 beads at 1 mm in diameter. Two channels were carved around the perimeter of the etched square in order to set two circular, rubber gaskets. An acrylic lid was placed on top with 24 round washer head screws (6 on each side) to create a watertight seal on the apparatus. Three ports were tapped with threads to accommodate a ¾ inch PVC plastic barb. The exterior barbs were used to maintain a consistent volume within the cell through injection as well as maintain a constant head on the apparatus. The middle cell was the location of injection and extraction regarding the yellow fluid. FIG. 12 shows a side profile of the apparatus loaded with 1 mm glass beads to model the porous media.

A Sony Cyber Shot DSC HX 300 20.4 Megapixel camera was mounted onto a tripod over the apparatus. The automatic portrait scenario set on a high resolution captured the flow of the invading fluid through the defending fluid. The location of the tripod remained consistent through the experiments and a piece of tape was placed on the cell to set the aperture window for each experiment. Once the camera was in place, a remote shutter was used to photograph the series of injections to ensure the camera did not move. This was important to maintain a consistent aperture window while conducting the experiments.

Apparatus Loading: The middle and one of the exterior barbs were removed from the cell as it is inverted at a 90-degree angle. The hole with the removed barb was placed towards the top. The apparatus was held at a vertical angle using a wooden support. Water was poured into a pot of clean, dry beads and 10 drops of blue dye were added per every 100 mL of water. This blue water slurry mixture was added to a beaker via a spoon and mixed to remove any air within the beaker. A red rubber hose was attached to the outlet of the beaker and placed into the well. The hose was inserted into the middle hole and the bead/blue water mixture was poured into the cell as shown in FIG. 13.

The middle barb was used to fill the apparatus until the blue/bead mixture overtopped the hole. A piece of mesh was added inside the barbed tube connection prior to reinserting into the cell. This mesh prevented beads from being extracted out of the apparatus during the pumping scheme. When the water level reached the middle hole, the barb was re inserted and covered with Parafilm to prevent any leaking of blue water as the water level rose about the barbed tube connection.

The beaker and hose were inserted into the top well to continue filling the cell. The blue water filled faster than the surface of the beads, so water was periodically pumped out of the cell down to the level of the beads. In addition to the saturation of the beads, a flexible yet stiff tube was inserted into the cell to release any trapped air caused by the descent of the beads into the existing slurry. A piece of mesh was added to the barbed tube connection prior to reinsertion. Once the barbed tube connection was tight, the cell was slowly lowered to a horizontal position for testing.

Injection and Extraction Method: Once the cell was placed horizontally, the tripod and camera were positioned. A consistent aperture was desired, so the camera was placed above the apparatus, zoomed into the same location every time and a remote shutter was employed to ensure camera stability. A beaker of yellow water was prepared for injection by adding 10 drops of yellow dye per 100 mL of water. The baseline scenario was conducted first.

Since there is no temperature difference in the baseline scenario, a 60 mL syringe was filled with yellow fluid and placed in the syringe pump. The other side of the pump contained an empty, blue syringe waiting to extract the blue fluid from the cell that was displaced by the yellow fluid. The valves were turned for pumping into the cell and the pump was set to the desired injection rate. The injection rates were 60 mL at one minute, two minutes, four minutes and 8 minutes. A picture was taken at every 10 mL of injected, yellow fluid into the cell for a total of 6 photographs per scenario. For example, the baseline scenario of 60 mL at 1 min had a photograph at a volume of 10 mL, 20 mL, 30 mL, 40 mL, 50 mL and 60 mL of injected, yellow fluid. This resulted in a total of 48 pictures to be analyzed for the presence of viscous fingering. The second syringe in the scheme removed the blue water at the same rate as yellow water was injected. Once the yellow fluid had been expelled into the apparatus, the pump was reversed. Now the extracted blue fluid was injected into the apparatus while the yellow dyed water was extracted into the syringe. The syringe discharged the green fluid into a waste container as described in FIG. 1.

The three ports as shown in the pumping scheme of FIG. 1 created a flow pattern that is similar to the classical dipole pattern (Fitts, 2013). While the flow pattern deviates from the dipole pattern at the extraction port, the injection port experiences this type of flow where the boundaries are relatively distant. At the well, it is a radial flow pattern.

Once the baseline scenario was complete, the apparatus was prepared for the temperature driven viscosity scenario. Three cups of ice were added to the blue water reservoir and drops of blue dye were added at a ratio to maintain consistency with the dying of the fluids. (USGS, 2020) . A beaker and hose were set on the opposite side of the cell and connected to the exterior barbed tube connection. The base of the beaker was set at a higher elevation than the bottom of the opening in the apparatus. The cold, blue fluid placed on ice was pumped through the cell starting at one of the exterior wells while the open-air drain discharged the displaced, warmer blue fluid into the beaker. This process injected 60 mL of cold, blue fluid six times to ensure the entire cell had been flushed off room temperature blue water. Furthermore, the apparatus had been placed in an ice bath to assist in maintaining a cold, blue base fluid.

The invading, yellow fluid was heated on a hot plate until the water boiled. The syringe was filled with hot water first, then the tube from the syringe to the valve and then the valve to the cell. The tubing from the valve to the syringe was fitted with insulation. The tubing from the valve to the cell was not insulated because the addition of insulation would block the view of the yellow fluid from the camera. The yellow fluid was injected at the predetermined rate and pictures were taken at 10 mL intervals until the final picture taken at 54 m. The process then followed FIG. 1 for the remainder of the temperature driven viscosity experiments.

Image Analysis: The images were analyzed using MATLAB R2020b. Each photograph was uploaded into MATLAB and analyzed with two different image analysis methods. The first method of analysis was a color segmentation method that uses K-means clustering. This method separates the colors within the image into three separate categories allowing the user to choose which cluster is most applicable for the analysis. For this study, cluster 2 isolates the plume and this image is converted to a binary image for further processing as shown in FIG. 7.

The second method of analysis was morphological structuring elements. This method is specific to shapes and assigns a value to each pixel in relation to the other pixels in its vicinity. Some of the functions that can be performed within this umbrella of commands are to fill holes, erode the perceived inconsistencies in the image per an assigned parameter and morphologically transform the shape based on user input. See FIG. 7.

Once the images had been processed and saved in the workspace, the next step for analysis was to upload the images in the Image Region Analyzer app. The area, perimeter, equivalent diameter and major/minor axis of length for the yellow plume were measured for each image processed under the two scenarios. The measurements for the baseline and thermally enhanced images were analyzed to compare the change in flow between the two scenarios.

Results: The Pélet Number for each injection interval was calculated based on the equivalent diameter of the plume as calculated from the image analysis. The velocity varies based on the injection rate as a function of time. The characteristic length is 0.1 cm throughout the calculations as well as D is 2.14×10⁻⁵ cm²/sec. TABLE 3 shows the average Pélet number over the course of each injection rate.

TABLE 3
Peclet number for each injection interval.

| Time (min) | Peclet number |
|---|---|
| 1 | 320 |
| 2 | 160 |
| 4 | 80 |
| 8 | 40 |

The analysis of a volume of 60 mL injected at 1, 2, 4 and 8 minute intervals depict a change in the perimeter of the plume within the 8-minute time step. This is shown in both the color segmentation by k clustering and morphological transformations. The number varies over the course of the injection due to the nature of the transformation as described in the Image Analysis section. The photographs for 40, 50, and 60 mL during the 8-minute interval show an increase in the perimeter of the plume that exceeds the baseline scenario.

The binary analysis maintains a constant Pélet number throughout the injection interval as shown in TABLE 3. There is a transition between the 30 mL and 40 mL photographs to a higher perimeter with the temperature dependent flow.

Discussion: For purposes of this discussion, the cold, blue water shall be known as the cool groundwater and the hot, yellow fluid will be known as the hot amendment. The viscosity at the measured temperature for water is calculated as follows (Sharqawy, 2010):

μ=4.2844×10⁻⁵+(0.157(T+64.993)²−91.296)⁻¹

where μ is the dynamic viscosity of water in (kg m⁻¹ s⁻¹) and T is temperature within the range of 0<T<100° C. at 0.1 MPa.

The viscosity is calculated using the fluid temperature at the time of injection for both the hot and cold water. TABLE 4 shows the measure temperatures of the cool groundwater and hot amendment as well as the mobility ratio for this scenario.

TABLE 4
Measured temperatures for the cool groundwater
and hot amendment with a mobility ratio of 1.2.

| | ° C. | ° F. |
|---|---|---|
| Cool Groundwater | 11 | 51.8 |
| Viscosity 1 (N*s/m²) | 0.0013 | 0.0005 |
| Hot Amendment | 73 | 163 |
| Viscosity 2 (N*s/m²) | 0.00039 | 0.0002 |
| Viscosity Ratio | 3.3 | 3.3 |
| Mobility Ratio (R) | 1.2 | 1.2 |

This paper uses perimeter as a parameter to detect the onset of viscous fingering. The perimeter of the plume reflects the changes in fingering behavior as the volume of each plume is consistent throughout the experiment. The perimeter of the thermally induced plume after the 30 mL mark during the 8-minute time interval increased up to 47% for the binary image analysis and up to 56% for the morphological image analysis.

It is important to note that the morphological and binary analysis result in similar increases in perimeter. The binary analysis is less dramatic as a visual example as the perimeter is categorized based on the flow within the image. It appears more as a fractal relationship. On the other hand, the morphological analysis erodes the fractals to create a more solid shape based on pixel values. While these two methods are different in the approach to the analysis, the combination of using these methods provides a more in depth understanding of the presence of viscous fingering. FIG. 7 and FIG. 9 show the baseline scenario overlaid on the thermally enhanced scenario for the binary and morphological analysis.

The morphological and binary analysis display a transition where the affected perimeter of the thermally induced plume exceeds the baseline scenario between 30 and 40 mL during the 8-minute scenario. This transition is not seen in the analysis of the 1, 2- and 4-minute intervals. The literature review suggests a critical Pélet number between 0 and 200 (Afshari, Hossein Hejazi, & Kantaz, 2018) which, according to TABLE 3, shows most scenarios within this range. However, the analysis for this experiment suggests a critical Pélet number exists at approximately 40. One possibility for the reduction in the critical Pélet range is the introduction of a porous media in the apparatus. As far as the author knows, there is no previous literature where the experimental results explored this relationship between Pélet number and viscous fingering with the use of a porous media.

In addition to a critical Pélet number, this paper demonstrates a critical volume at which thermally induced flow triggers the onset of additional perimeter. This break through between the injected volume of 30 and 40 mL will require further analysis to determine the implications of this finding.

Furthermore, the temperature of the hot amendment is consistent for each scenario as shown in TABLE 4 for a mobility ratio of 1.2. Time is the remaining parameter to be manipulated for viscous fingering and, based on the results, promotes this behavior as the injection rate decreases. This is counterintuitive as it seems the slower velocity of the invading fluid would have reduced fingering behavior. However, these results are consistent with the analysis performed by Nagel and Videback (2019). The scenario with a larger time interval would reach thermal equilibrium first thus negating the effects of the viscosity difference from the manipulation of temperature. However, the experimental results show this is not the case with viscous fingering emerging within the slower injection rates. Therefore, this paper proposes a maximum Pélet number of approximately 40 to induce viscous fingering in an experimental apparatus with porous media. Further research is required to find the minimum Pélet number range (Nagel & Videback, 2019) or confirm the minimum is 0 (Afshari, Hossein Hejazi, & Kantaz, 2018).

The following patents, applications and publications as listed below and throughout this document are hereby incorporated by reference in their entirety herein.

### Reference List for Example 1

1. Cirpka, O. A. Effects of sorption on transverse mixing in transient flows. J. Contam. Hydrol. 2005, 78, 207-229. https://doi.org/10.1016/j.jconhyd.2005.05.008.
2. Sposito, G. Chaotic solute advection by unsteady groundwater flow. Water Resour. Res. 2006, 42, W06D03. https://doi.org/10.1029/2005WR004518.
3. Bagtzoglou, A. C.; Oates, P. M. Chaotic advection and enhanced groundwater remediation. J. Mater. Civ. Eng. 2007, 19, 75-82. https://doi.org/10.1061/(ASCE)0899-1561(2007)19:1(75).
4. Mays, D. C.; Neupauer, R. M. Plume spreading in groundwater by stretching and folding. Water Resour. Res. 2012, 48, W07501. https://doi.org/10.1029/2011WR011567.
5. Zhang, P. F.; DeVries, S. L.; Dathe, A .; Bagtzoglou, A. C. Enhanced mixing and plume containment in porous media under time-dependent oscillatory flow. Environ. Sci. Technol. 2009, 43, 6283-6288. https://doi.org/10.1021/es900854r.
6. Sather, L. J.; Roth, E. J.; Neupauer, R. M.; Crimaldi, J. P.; Mays, D. C. Experiments and simulations on plume spreading by engineered injection and extraction in refractive index matched porous media. Water Resour. Res. 2023, 59, e2022WR032943. https://doi.org/10.1029/2022WR032943.
7. Lester, D.; Metcalfe, G.; Trefry, M. G.; Ord, A.; Hobbs, B.; Rudman, M. Lagrangian topology of a periodically reoriented potential flows Symmetry, optimization, and mixing. Phys. Rev. E 2009, 80, 036298. https://doi.org/10.1103/PhysRevE.80.036208.
8. Cho, M. S.; Solano, F.; Thomson, N. R.; Trefry, M. G.; Lester, D. R.; Metcalfe, G. Field trials of chaotic advection to enhance re-agent delivery. Ground Water Monit. Remediat. 2019, 39, 23-39. https://doi.org/10.1111/gwmr.12339.
9. Videbæk, T. E.; Nagel, S. R. Diffusion-driven transition between two regimes of viscous fingering. Phys. Rev. Fluids 2019, 4, 033902. https://doi.org/10.1103/PhysRevFluids.4.033902.
10. Flowers, T. C.; Hunt, J. R. Viscous and gravitational contributions to mixing during vertical brine transport in water-saturated porous media. Water Resour. Res. 2007, 43, W01407. https://doi.org/10.1029/2005WR004773.
11. Saffman, P. C. Viscous fingering in Hele-Shaw cells. J. Fluid Mech. 1986, 173, 73-94. https://doi.org/10.1017/S0022112086001088.
12. Chen, J.-D. Radial viscous fingering patterns in Hele-Shaw cells. Exp. Fluids 1987, 5, 363-371. https://doi.org/10.1007/BF00264399.
13. Homsy, G. M. Viscous fingering in porous media. Annu. Rev. Fluid Mech. 1987, 19, 271-311. https://doi.org/10.1146/annurev.fluid.19.1.271.
14. Saghir, M. Z.; Chaalal, O.; Islam, M. R. Numerical and experimental modeling of viscous fingering during liquid-liquid miscible displacement. J. Pet. Sci. Eng. 2000, 26, 253-262. https://doi.org/10.1016/S0920-4105(00)00039-5.
15. Jha, B.; Cueto-Felgueroso, L.; Juanes, R. Fluid mixing from viscous fingering. Phys. Rev. Lett. 2011, 106, 194502. https://doi.org/10.1103/PhysRevLett.106.194502.
16. Sandnes, B.; Flekkøy, E. G.; Knudsen, H.A.; Måløy, K. J.; See, H. Patterns and flow in frictional fluid dynamics. Nat. Commun. 2011, 2, 288. https://doi.org/10.1038/ncomms1289.
17. Afshari, S.; Hejazi, S. H.; Kantzas, A. Role of medium heterogeneity and viscosity contrast in miscible flow regimes and mixing zone growth: A computational pore-scale approach. Phys. Rev. Fluids 2018, 3, 054501. https://doi.org/10.1103/PhysRevFluids.3.054501.
18. Kaslusky, S. F.; Udell, K. S. Co-Injection of air and steam for the prevention of the downward migration of DNAPLs during steam enhanced extraction: An experimental evaluation of optimum injection ratio predictions. J. Contam. Hydrol. 2005, 77, 325-347. https://doi.org/10.1016/j.jconhyd.2005.02.003.
19. Kosegi, J. M.; Minsker, B. S.; Dougherty, D. E. Feasibility study of thermal in situ bioremediation. J. Environ. Eng. 2000, 126, 601-610. https://doi.org/10.1061/(ASCE)0733-9372(2000)126 7(601).
20. Payne, F. C.; Quinnan, J. A.; Potter, S. T. Remediation Hydraulics; CRC Press: New York, NY, USA, 2008.
21. Jackson, S. J.; Power, H.; Giddings, D. Immiscible thermo-viscous fingering in Hele-Shaw cells. Comput. Fluids 2017, 156, 621-641. https://doi.org/10.1016/j.compfluid.2017.04.004.
22. Islam, M. N.; Azaiez, J. Thermo-viscous fingering in quarter five-spot miscible displacements. Eur. J. Mech. B/Fluids 2011, 30, 107-119. https://doi.org/10.1016/j.euromechflu.2010.07.004.
23. Tigera, R. G. Temperature Dependent Viscosity Driven Mixing in a Quasi-2D Porous Media Apparatus. Master's Thesis, Department of Civil Engineering, University of Colorado Denver: Denver, CO, USA, 2020.
24. Dullien, F. A. L. Porous Media: Fluid Transport and Pore Structure, 2nd ed .; Academic Press: Cambridge, MA, USA, 1992.
25. Repplier, F. N.; Rell, M. M.; Columbia, R. K. MS-21 Groundwater Temperatures Map of Colorado. In Colorado Geological Survey; Department of Natural Resources: Denver, CO, USA, 1981. Available online: https://coloradogeologicalsurvey.org/publications/groundwater-temperatures-map-colorado (accessed on 30 September 2022).
26. Sharqawy, M. H.; Lienhard, V. J. H.; Zubair, S. M. The thermophysical properties of seawater: A review of existing correlations and data. Desalination Water Treat. 2010, 16, 354-380. http://doi.org/10.5004/dwt.2010.1079.
27. Dahal, U.; Adhikari, N. P. Molecular dynamics study of diffusion of heavy water in normal water at different temperatures. J. Mol. Liq. 2012, 167, 34-39. https://doi.org/10.1016/j.molliq.2011.12.008.
28. Math Works, Matlab 9.7.0.1319299 (R2019b) Update 5; Math Works: Natick, MA, USA, 2020.
29. Sharma, V.; Nand, S.; Pramanik, S.; Chen, C.-Y.; Mishra, M. Control of radial miscible viscous fingering. J. Fluid Mech. 2020, 884, A16. https://doi.org/10.1017/jfm.2019.932.
30. An, B.; Solorzano, D.; Yuan, Q. Viscous fingering dynamics and flow regimes of miscible displacements in a sealed Hele-Shaw cell. Energies 2022, 15, 5798. https://doi.org/10.3390/en15165798.

### Reference List for Example 2

Afshari, S., Hossein Hejazi, S., & Kantaz, A. (2018). Role of medium heterogeneity and viscosity contrast in miscible flow regimes and mixing zone growth: A computational pore scale approach. Physical Review Fluids (3), 1-28.
Azaiez, J., & Islam, M. (2017). Thermo-viscous fingering in quarter five spot miscible displacements. European Journal of Mechanics B—Fluids, 30(1), 107-119.
Azaiez, M., & Saljadi, J. (2013). Scaling and Unified Characterization of flow instabilities in layered heterogeneous porous media. Physical Review E 88.
B. Sandnes, E. F. (2011). Patterns and Flow in Frictional Fluid Dynamics. Nature Communications, 1-8.
Birenda Jha, L. C.-F. (2011). Quantifying mixing in viscously unstable porous media flows. Cambridge, Massachusetts: Physical Review.
Birenda, J., James, R., & Cueto-Felgueroso, L. (2011). Fluid Mixing from Viscous Fingering. Cambridge, Massachusetts: Physical Review Letters.
Chen, J. (1987). Radial viscous fingering patterns in Hele Shaw Cells. Experiments in Fluids, 363-371.
Chen, J. (1989). Growth of radial viscous fingers in a Hele Shaw Model. Journal of Fluid Mechanics, 223-243.
Chuoke, R., van Meurs, P., & van der Poel, C. (1959). The Instability of Slow, Immiscible Viscous Liquid Displacements in Permeable Media. Society of Petroleum Engineers, 188-194.
City of Aurora. (1996). Section 138-154 Use of independent water system; cross connection; use of Dawson Aquifer. In CITY CODE OF THE CITY OF AURORA, COLORADO VOLUME I. City of Aurora, CO: Municipal Code Corporation and the City of Aurora, Colorado. 1996.
Dahal, U., & Adhikari, N. P. (2012). Molecular Dynamics study of diffusion of heavy water in normal water at different temperatures. Journal of Molecular Liquids, 34-49.
Dassargues, M. H. (2004). Review of the use of Pélet Numbers to determine the relative importance of advection and diffusion in low permeability environments. Hydrogeology Journal 1.
Elder, J. (1968). The unstable thermal interface. Journal of Fluid Mechanics, 69-96.
Fitts, C. (2013). 7—Modeling Steady Flow with Basic Methods. In C. Fitts, Groundwater Science (Second Edition) (pp. Pages 243-304). San Francisco: Academic Press.
Foster, S., & Chilton, P. (2003). Groundwater: the processes and global significance of aquifer degradation. Philosophical Transactions of the Royal Society, 1957-1972.
G. M. Homsy. (1987). Viscous Fingering in Porous Media. Annual Review of Fluids, 19, 271-311.
Griffiths, R. (1985). Thermals in extremely viscous fluids, including the effects of temperature dependent viscosity. Journal of Fluid Mechanics, 115-138.
Homsy, G., & Zimmerman, W. (1992). Viscous Fingering in Miscible Displacements: Unification of viscosity contrast, anisotropic dispersion, and velocity dependence of nonlinear finger propagation. Physics of Fluids A: Fluid Dynamics, 2348.
J. M. Kosegi, B. M. (2000). Feasibility study of thermal in situ bioremediation. Journal of Environmental Engineering—ASCE, 126(7), 601-610.
Jackson, S., Power, H., & Gidings, D. (2017). Immiscible thermo viscous fingering in Hele Shaw cells. Computers & Fluids, 156, , 621-641.
Jones, M. (2014). Chaotic Advection from Stretching and Holding in a Hele Shaw Cell. Digital Auraria, 1-55.
Llamas, M., & Custodio, E. (2002). Intensive use of groundwater: a new situation which demands proactive action. Intensive use of Groundwater, 13-31.
M. H. Sharqawy, J. L. (2010). Thermophysical Properties of Sea Water: A Review of Existing Correlation and Data. Desalination and Water Treatment, 354-380.
M. Z. Saghir, O. C. (2000). Numerical and Experimental Modeling of Viscous Fingering During Liquid—Liquid Miscible Displacement. Journal of Petroleum Science and Engineering, 26, 253-262.
Nagel, T., & Videbaek, S. (2019). Diffusion-driven transition between two regimes of viscous fingering. Physical Review Fluids, 033902 1-16.
Patterson, L. (1981). Radial fingering in a Hele Shaw Cell. J. fluid Mechanics, 513-529.
Tan, C., & Homsy, G. (1988). Simulation of nonlinear viscous fingering in miscible displacements. The Physics of Fluids, 1330.
Tan, C., & Homsy, G. (1992). Viscous Fingering with Permeability Heterogeneity. Physics of Fluids, 1099.
Taylor, P., & Saffman, G. (1958). The penetration of a fluid into a porous medium or Hele Shaw cell containing a more viscous liquid. Royal Society, 312-332.
USGS. (2020, 10 15). Water Density. Retrieved from United States Geological Survey: https://www.usgs.gov/special-topic/water-science-school/science/water-density?qt-science_center_objects=0#qt-science_center_objects

What is claimed is:

1. A method of enhancing plume spreading, the method comprising:
injecting a first fluid having a first viscosity into a second fluid having a second viscosity;
wherein the first viscosity is lower than the second viscosity; and
wherein an interface between the first fluid and the second fluid has a surface area that is greater than a reference surface area of an interface between two fluids having a same viscosity, thereby enhancing plume spreading of the first fluid into the second fluid.

2. The method of claim 1, wherein the first fluid has a first temperature and the second fluid has a second temperature; and
wherein the first temperature is higher than the second temperature.

3. The method of claim 3, wherein the first temperature is higher than the second temperature by from about 10° C. to about 100° C.

4. The method of claim 1, wherein the first fluid further comprises a viscosity reducing agent.

5. The method of claim 4, wherein the viscosity reducing agent comprises a detergent, surfactant, excipient, or any combination thereof.

6. The method of claim 1, wherein a mobility ratio (i.e., log viscosity ratio) between the first fluid and the second fluid is from about 1 to about 2.

7. The method of claim 1, wherein the first fluid and the second fluid are both liquids.

8. The method of claim 7, wherein the first fluid is water and comprises a soluble reactant.

9. The method of claim 8, wherein the soluble reactant comprises a remediation amendment, a lixiviant, or a combination thereof.

10. The method of claim 9, wherein the remediation amendment comprises a reactant for chemical oxidation (e.g., potassium permanganate), a reactant for bioremediation (e.g., molasses), or a combination thereof.

11. The method of claim 9, wherein the lixiviant comprises a carbonate solution (e.g., sodium bicarbonate) or an acid solution (i.e., sulfuric acid).

12. The method of claim 7, wherein the second fluid is groundwater.

13. The method of claim 1, wherein the interface comprises viscous fingering.

14. The method of claim 1, wherein the surface area of the interface is greater than the reference surface area by from about 20% to about 140%.

15. A method of groundwater remediation, the method comprising:
injecting a fluid into a portion of groundwater;
wherein the fluid has a first temperature and comprises a remediation amendment;
wherein the groundwater has a second temperature and comprises at least one contaminant;
wherein the first temperature is higher than the second temperature;
wherein an interface between the groundwater and the injected fluid has a surface area that is greater than a reference surface area of an interface between groundwater and a reference injected fluid at the second temperature; and
wherein the remediation amendment diffuses into the groundwater at the interface, thereby destroying, transforming, or immobilizing the at least one contaminant.

16. The method of claim 15, wherein the at least one contaminant comprises hydrocarbons such as benzene, organic solvents such as trichloroethylene, heavy metals such as chromium, radionuclides such as uranium, or other contaminants dissolved in water.

17. The method of claim 15, wherein the fluid is an aqueous solution the remediation amendment comprises a reactant for chemical oxidation (e.g., potassium permanganate), a reactant for bioremediation (e.g., molasses), or a combination thereof.

18. The method of claim 15, wherein the first temperature is higher than the second temperature by from about 10° C. to about 100° C.

19. The method of claim 15, wherein the fluid further comprises a viscosity reducing agent, and wherein the viscosity reducing agent comprises a detergent, surfactant, excipient, or any combination thereof.

20. The method of claim 15, wherein the surface area of the interface is greater than the reference surface area by from about 20% to about 140%.
